(19) United States
(12) Patent Application Publication
(10) Pub. No.: US 2017/0105331 A1
(43) Pub. Date: Apr. 20, 2017

(54) Soil-Cultivation Unit and Soil-Cultivation Method for Conservation-Type Soil Cultivation

(71) Applicant: Technische Universität Dresden, Dresden (DE)

(72) Inventors: Thomas Herlitzius, Coswig (DE); Andre Grosa, Bieberstein (DE); Tim Bögel, Dresden (DE)

(21) Appl. No.: 15/303,223

(22) PCT Filed: Jun. 18, 2015
(86) PCT No.: PCT/DE2015/000315

§ 371 Date: Oct. 11, 2016

(30) Foreign Application Priority Data
Jun. 19, 2014 (DE) 10 2014 009 090.6

(51) Int. Cl. A01B 63/24; B62D 49/00; A01B 19/00

(52) U.S. Cl. CPC A01B 63/24; A01B 19/00; B62D 49/00

(57) ABSTRACT

The invention relates to a soil-cultivation unit, comprised of a tractor (21) and a driven soil-cultivation machine or comprised of a tractor (21) and a passive, pulled soil-cultivation device (22) for conservation-type soil cultivation, having an equipment carrier with cultivator tools for accommodating one or more cultivator tines (6), characterized in that
a regulation unit (23) is provided that accesses data that is recordable before and after travel over the work area in the work process and during the work process,
control elements (10) are provided, via which the cutting geometry of the cultivator tines (6) can be adjusted,
the regulation unit (23) is set up in such a way that control variables can be generated from the recorded data for setting the cutting geometry during the work process, and
the cutting geometry of the cultivator tines (6) is can be permanently adjusted during the work process as a result of the control variables that are generated.

A corresponding soil-cultivation method is described.

### CROSS REFERENCE TO RELATED APPLICATIONS

This application is the U.S. national stage of International Application No. PCT/DE2015/000315, filed on 2015 Jun. 18. The international application claims the priority of DE 102014009090.6 filed on 2014 Jun. 19; all applications are incorporated by reference herein in their entirety.

### BACKGROUND

The invention relates to a soil-cultivation unit and a soil-cultivation method for conservation-type soil cultivation according to the preambles of claims 1 and 12.

Non-inverting, conservation-type soil-cultivation methods are used on more than ⅔ of agricultural acreage. The moisture in the soil is conserved, a top layer of plant residues is left on the surface of the soil and evaporation and erosion protection are consequently ensured with this type of soil cultivation. Moreover, the objective of the work is to create a defined crumb structure in the soil.

Passive devices that are pulled or active machines driven by the tractor power take-off are used for the soil cultivation. Cultivators are devices that are pulled and are used as universally applicable work implements. Known work implements are comprised of a welded frame with cultivator tools on 2-4 (-8) crossbars. The actual cultivator tool is comprised of a tool console, a leg with a tine holder and a tine. Rigid cultivator legs for heavy soil and/or deep soil cultivation or spring-type tools (spring tines and comb tines) for shallow soil cultivation are well known. Rigid cultivator legs can be coupled to the frame so as to be movable. This movable coupling serves as overload protection exclusively when there is contact with stones or obstacles. Mechanical systems using springs or hydro-pneumatic systems with hydraulic cylinder—pressure reservoir combinations are known.

The tine penetrates into the soil and lifts the soil, the soil glides over the tine surface and forms a more or less thick or high soil roll towards the front; the soil crumbles and is mixed with vegetation or plant residues in the process. Modern-day tines have, depending on the size, a relatively strong curvature around the transverse axis with radii between 200 and 400 mm. This curvature makes a tossed-up, mixing type of operation possible with slower operating speeds of 5 to 8 km/h.

The angular relationships and the tool shape, in particular the curvature, determine the manner of operation and the tractive force requirements of the tine (FIG. 1), especially the existing angle of spread φ or the tilt angle of the tine α. Strong soil dynamics and therefore a strong mixing effect result from a steep tilt angle of the tine or, as the case may be, a smaller curvature radius r of the tine.

A drawback is that the manner of operation of the cultivator tine changes with the operating speed. Very diverse tine geometries are used to keep control over the circumstances. The double diamond-shaped tine (FIG. 1) and the duckfoot tine (FIG. 3) are shapes that are frequently used. The use of lateral wings (FIG. 2) for cutting through the entire surface of the soil is also known.

Furthermore, methods are known that adjust work implements, e.g. cultivators, or parts of them, e.g. tool sections, based on digital field data. These settings can be specific to the location and, as an example, have the operating depth of the tools as a control variable. The field data, for instance the soil resistance or the soil type, is registered at arbitrary points in time during various work trips over the year and stored in a digital field-data file. The computer on the tractor can use these processed data sets for device or machine settings.

A method and a device for ascertaining data regarding the status of an agricultural field are known, as an example, from EP 0 749 677 A1. The power requirements of a soil-cultivation machine or device necessary for the cultivation are determined in the process, and the respective power requirements are recorded in connection with the site.

Furthermore, a soil-cultivation device with soil-cultivation tools that are arranged in an adjustable upright direction with respect to a device frame is known from DE 101 45 112 A1. A field map with stored information specific to the location regarding the penetration depth of the soil-cultivation tools in the soil is located in an electronic control unit and/or regulation unit. The setting for the penetration depth (operating depth) is controlled in a location-specific way based on the data stored in the field map.

### SUMMARY

The invention relates to a soil-cultivation unit, comprised of a tractor (21) and a driven soil-cultivation machine or comprised of a tractor (21) and a passive, pulled soil-cultivation device (22) for conservation-type soil cultivation, having an equipment carrier with cultivator tools for accommodating one or more cultivator tines (6), characterized in that
a regulation unit (23) is provided that accesses data that is recordable before and after travel over the work area in the work process and during the work process,
control elements (10) are provided, via which the cutting geometry of the cultivator tines (6) can be adjusted,
the regulation unit (23) is set up in such a way that control variables can be generated from the recorded data for setting the cutting geometry during the work process, and
the cutting geometry of the cultivator tines (6) is can be permanently adjusted during the work process as a result of the control variables that are generated.

A corresponding soil-cultivation method is described.

### DETAILED DESCRIPTION

The object of the instant invention is to specify a device for non-inverting, conservation-type soil cultivation that obviates the need for a diversity of tine geometries and that brings about consistent soil cultivation independent of the soil quality and the operating speed. The soil cultivation is to be carried out in dependence upon the currently existing state of the soil.

The problem is solved in accordance with the invention with the features specified in claim 1. Advantageous variants follow from the features specified in the subordinate claims.

The problem is further solved by a soil-cultivation method with the features specified in claim 12.

The solution that is proposed is comprised of a soil-cultivation unit, constituting a tractor and a driven soil-cultivation machine or constituting a tractor 21 and a passive, pulled soil-cultivation device 22, further including an equipment carrier with cultivator tools for accommodating one or more tines. Sensors that capture input parameters for regulation, for instance the height of vegetation, the degree of coverage, the crumb structure and the soil relief, are attached in the front and back, as well as in the tool area, of the machine system. The driven soil-cultivation machine or the pulled soil-cultivation device has setting possibilities to change the manner of operation. In the case of driven soil-cultivation machines, that could be, as is well known, the rotary speed of the rotor or gyroscope. In the case of pulled soil-cultivation devices, setting possibilities that could influence the manner of operation are lacking.

Furthermore, it is important with regard to the invention that there is a permanent setting of the cutting geometry during the field work. A regulation unit is provided for the permanent setting capability of the cutting geometry during the field work; the cutting geometry of the cultivator tines is influenced by it in dependence upon the recorded measurement parameters, preferably the operating speed, the operating depth and the toss-up height. To this end, control variables are sent by the regulation unit to control elements to change the operating depth of the cultivator tines, of the tilt angle or swivel angle and/or the angle of spread.

The permanent setting capability of the parameters of the operating depth of the cultivator tines, the tilt angle or the swivel angle and/or the angle of spread as regulation variables advantageously takes place in dependence upon the essential parameters to be recorded, the status of vegetation, the operating speed, the operating depth and toss-up height, the mixing intensity, the degree of coverage, the soil relief and the crumb structure, that vary during the soil cultivation. These variables can be measured or recorded in other ways during the trip in front of (input parameter), in (process variable) and in back of (operating-result parameter) the soil-cultivation unit. The status of vegetation can be measured or recorded in front of the soil-cultivation unit; the operating speed, the operating depth, the toss-up height and the mixing intensity can be measured or recorded in the soil-cultivation unit and the degree of coverage, the soil relief and the crumb structure can be measured or recorded in back of the soil-cultivation unit.

An adjustment unit is advantageously provided on the cultivator tool or on the tine that makes adjustments possible to the operating depth of the tine, the tilt angle of the tine or the angle of spread of the tine—individually or in different combinations—before and during the work on the field. An adjustment during the work on the field takes place as described above.

An adjustment algorithm for the adjustment possibilities of the operating depth before the field work is advantageously provided, just as it is already used to influence the preliminary furrow width during the automatic setting of the plow.

The parameter angle of spread can be permanently set in an advantageous way in dependence upon the operating depth. A quick device retraction to the target operating depth at the headland can be achieved with a temporary setting of a small angle of spread, for instance.

The permanent adjustability of the operating depth of an individual tool or a group of tools is also advantageously provided in dependence upon the wear status or the wear and tear on the tool as a disturbance variable. The device can be adjusted during the field work here in the form of regulation (with feedback) or in the form of control or open control. The disturbance variables are recorded with suitable sensors.

Various strategies can be used, e.g. tractive force—optimized or with a constant manner of operation, for instance the same mixing intensity—with a closed control loop.

It becomes possible with the regulation unit for controlling the soil cultivation to achieve work quality that is uniform to a great extent, even at different operating speeds (traveling uphill/downhill). Furthermore, different operating strategies can be used that are geared towards a constant degree of coverage for erosion protection or a defined clod size.

The need for tractive force that progressively increases with the operating speed (around 3-fold tractive force/diesel consumption at twice the operating speed) can be reduced via the invention, and an operating speed greater than 8 km/h can be controlled with an optimized tractive force by influencing the cutting geometry. A positive influence on the negative effects on the operating manner during greater operating speeds, such as increasing soil dynamics and mixing effects, is therefore possible.

### BRIEF DESCRIPTION OF THE DRAWINGS

The invention will be explained in more detail below with the aid of examples. The accompanying schematic diagrams show the following:

FIG. 1 shows the basic structure, the angle relationships and the processing floor at the double diamond-shaped tine

FIG. 2 shows the basic structure, the angle relationships and the processing floor at the double diamond-shaped tine with wings

FIG. 3 shows the basic structure, the angle relationships and the processing floor at the duckfoot tine (one piece)

FIG. 4 shows the soil-cultivation unit comprised of a tractive machine (e.g. tractor) and a passive, pulled soil-cultivation device (e.g. cultivator) with a regulation unit to control the operating process

FIG. 5 shows an agricultural soil-cultivation device with an example of an arrangement of cultivator tools in 4 rows with a diagram of the adjustable cultivator tools as per the invention in the form of an example

FIG. 6 shows a side view of FIG. 5 with cultivator tools one in back of the other in the direction of travel

FIG. 7 shows a section of a front view of FIG. 5 with cultivator tools arranged next to one another and a diagram of the processing floor that is being formed

FIG. 8 shows a diagram to illustrate the adjustability of the angle of spread of the attached tine wings and therefore the capability of realizing two or more tine geometries

FIG. 9 shows a diagram to illustrate the adjustability of the tilt angle

FIG. 10 shows a diagram of a change to the tilt angle via rotation around a crosswise axis close to the cultivator leg fixture and the vertical tine adjustment (of the individual leg in the cultivator leg fixture or the leg group via adjustment of the entire crossbar)

### DETAILED DESCRIPTION OF THE PREFERRED EMBODIMENTS

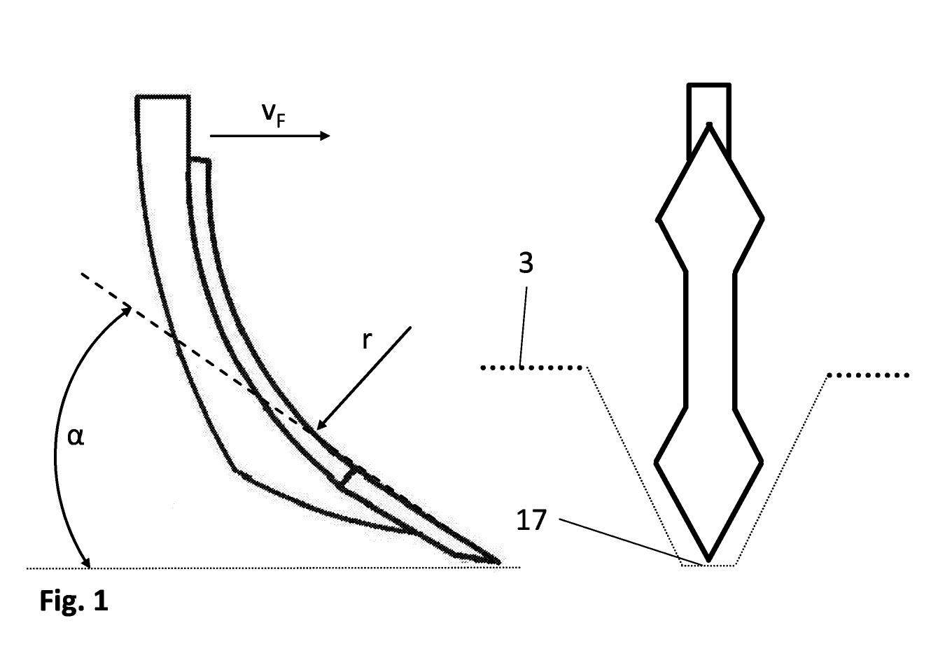

The diagrams in FIGS. 1 to 3 show the prior art; reference was made to this at the outset of the description. An essential criterion for the operation is the formation of a processing floor that is influenced, in particular, by the shape of the tine tip and the wing position.

FIG. 1 shows a tine tool in the form of a double diamond with a marking of the tilt angle α as a characteristic feature of the cutting geometry.

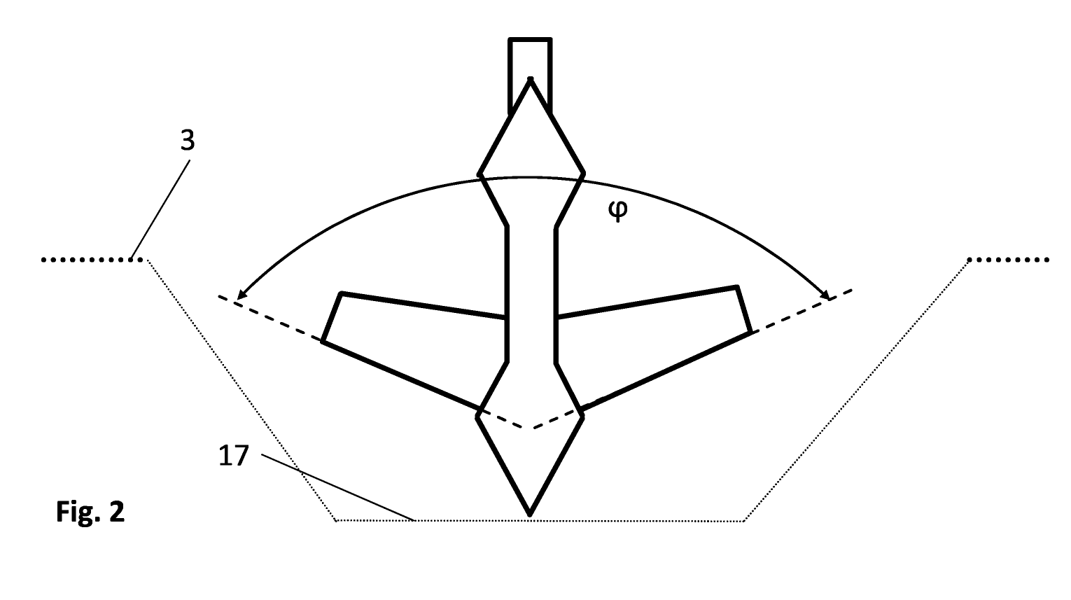

FIG. 2 shows a tine tool with additional wings with a marking of the angle of spread φ as a characteristic feature of the cutting geometry.

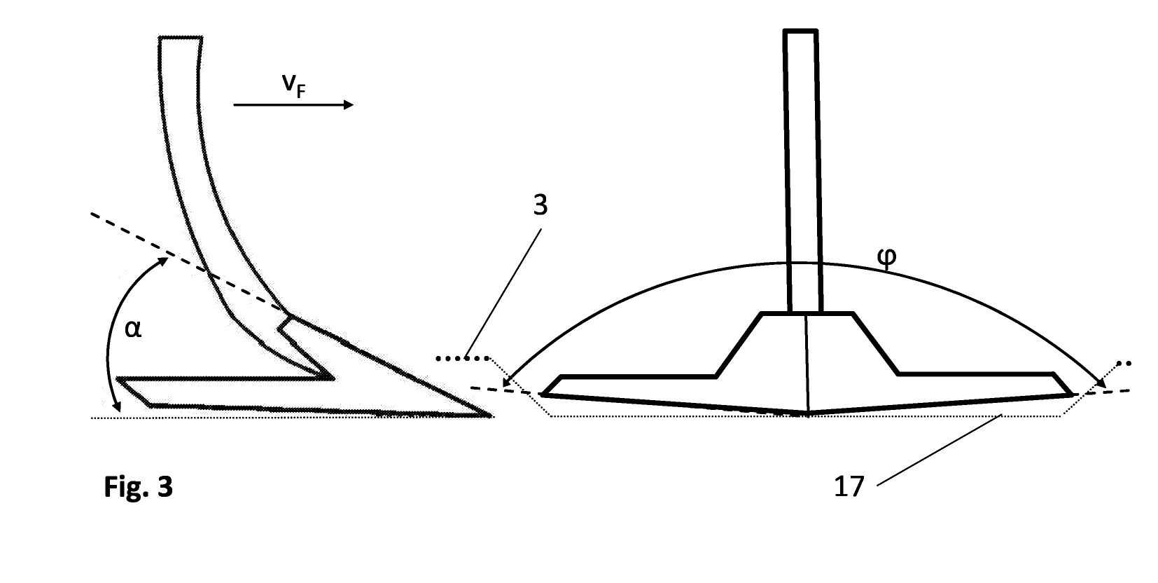

FIG. 3 shows a flat cutting tine tool with a marking of the tilt angle α and the angle of spread φ as characteristic features of the cutting geometry.

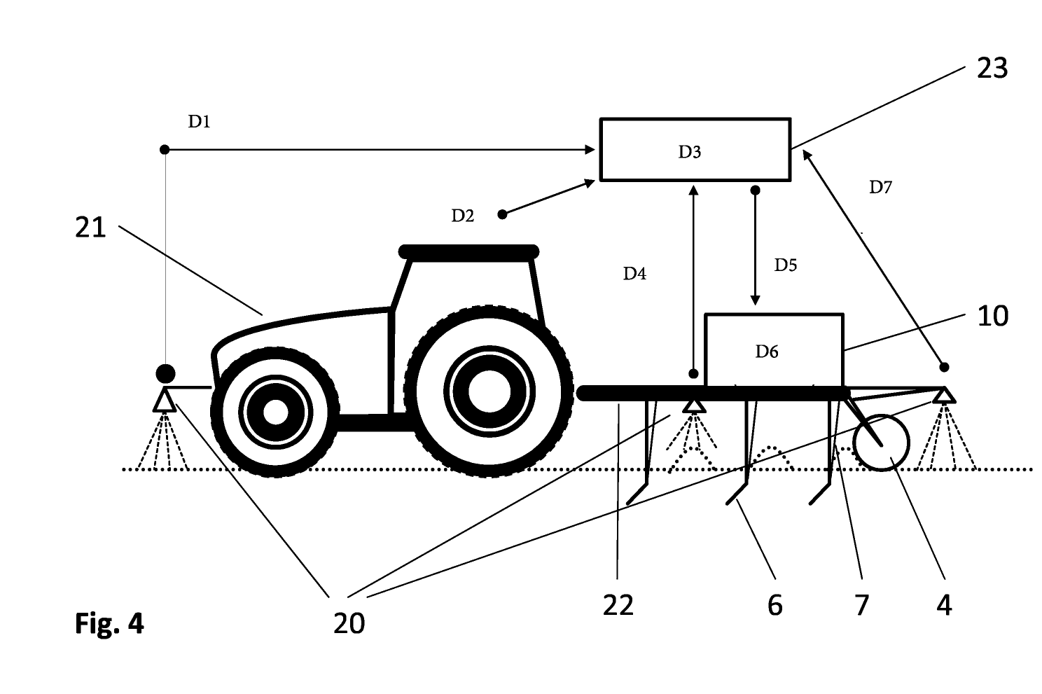

A cultivation unit as per the invention is shown in FIG. 4. It is comprised of a tractor 21 and a passive, pulled soil-cultivation device 22. Several cultivator tines 6 with adjustment rods 7 and a supporting body, which is designed in the form of a support wheel 4, are located on the passive, pulled soil-cultivation device 22. A control element 10, in this case an actuator, is attached to the soil-cultivation device 22 to provide an influence via the adjustment rods 7.

Sensors that detect the soil height or the degree of coverage, or the status of vegetation as the case may be, are located on the tractor 21 to record the measured data in front of the cultivation area. To record data regarding the operating process (e.g. tossing height and mixing intensity), sensors are in turn located on the soil-cultivation device 22 in the area of the working tools to detect the process parameters, and sensors are located at the end of the soil-cultivation device 22 to detect the results of the work (e.g. the degree of coverage of the ground, the soil relief and the crumb structure). This measurement data is made available, in addition to the travel speed, to a regulation unit 23. From the data that is available, the regulation unit 23 ascertains the control variable for the control element 10, which is the cylinder stroke in this case.

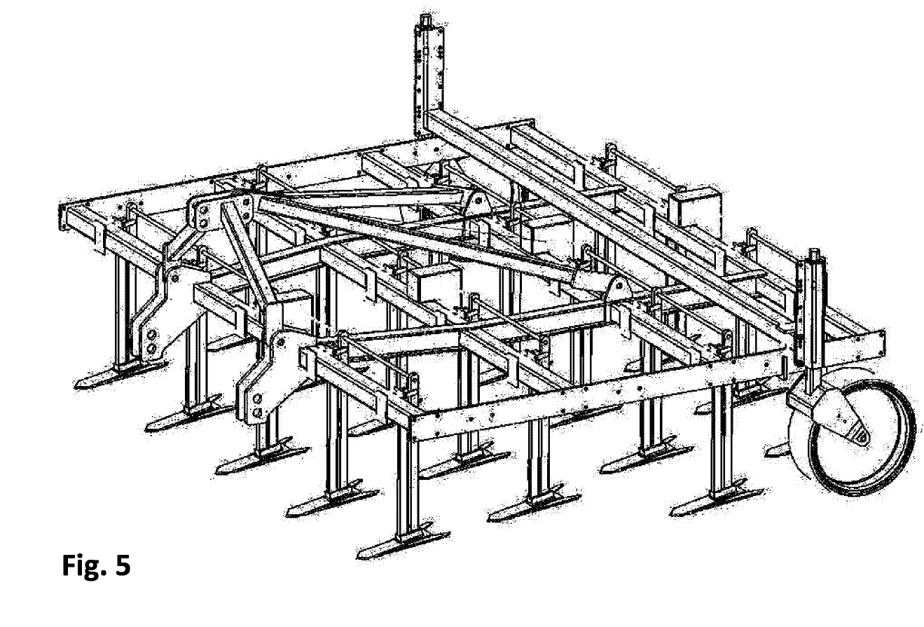

An agricultural device with a typical arrangement of cultivator tools as per the invention in a 4-beam design, suitable for non-inverting, i.e. conservation-type, soil cultivation, is shown in FIG. 5. The tools work in a loosening and mixing manner and are used at different operating depths for stubble processing (shallow) or base soil cultivation (deep), as well as seedbed preparation.

The device is comprised of several loosening tools arranged crosswise to the direction of travel with a line distance s. The overall machine frame 1 is guided in terms of depth by support wheels 4. This can, as an alternative, also take place via trailing or roll-off, cylinder-shaped tools such as roller tillers, for instance.

The loosening tools are adjustably arranged in terms of the parameters of operating depth of the tool and the tilt angle of the tine on the machine frame 1 as per the invention. Furthermore, the angle of spread of the tine additions, in particular so-called wings, can be designed to be adjustable.

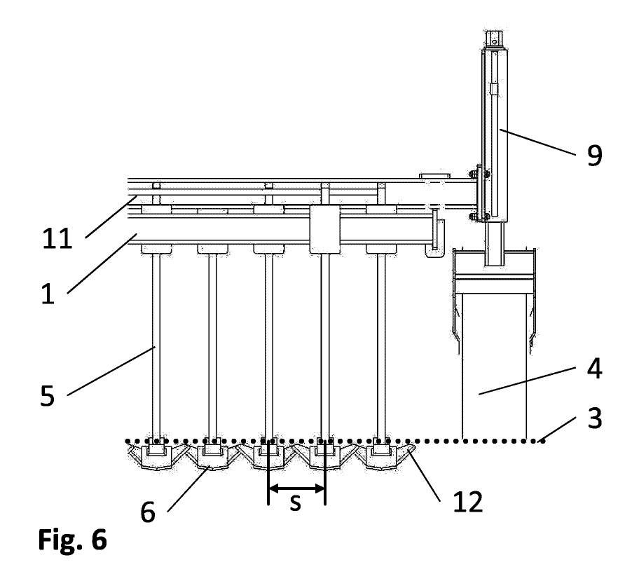

FIG. 6 shows the tool arrangement of FIG. 5 as per the invention in a front view. The cultivator tines 6 attached to the cultivator legs 5 have a line distance s from one another. The cultivator legs 5 are connected at the top to the machine frame 1. The machine frame 1 can be lifted or lowered with respect to the surface of the soil 3, and the operating depth of the cultivator tines 6 can be adjusted in that way, via the height adjustment 9 on the support wheel 4.

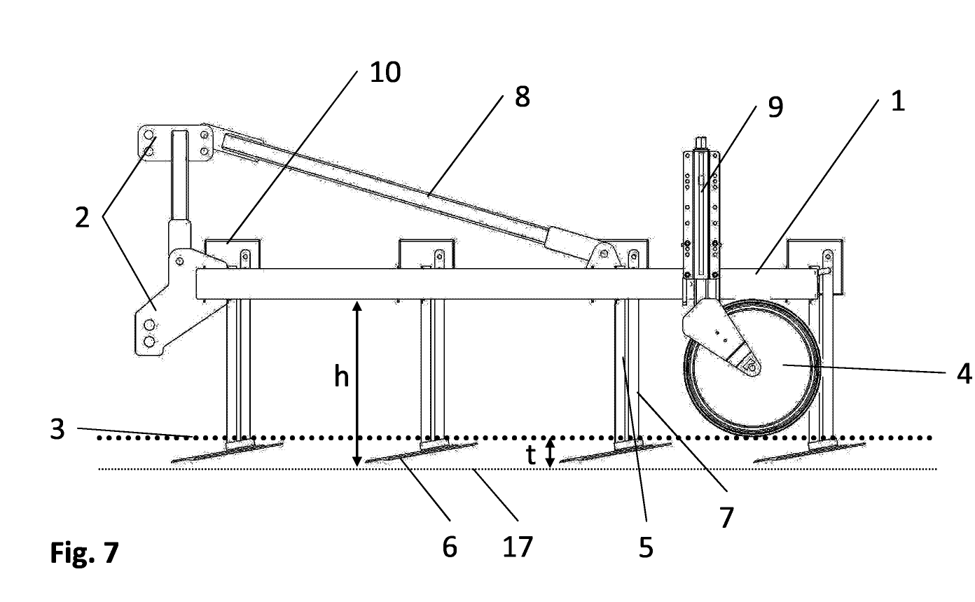

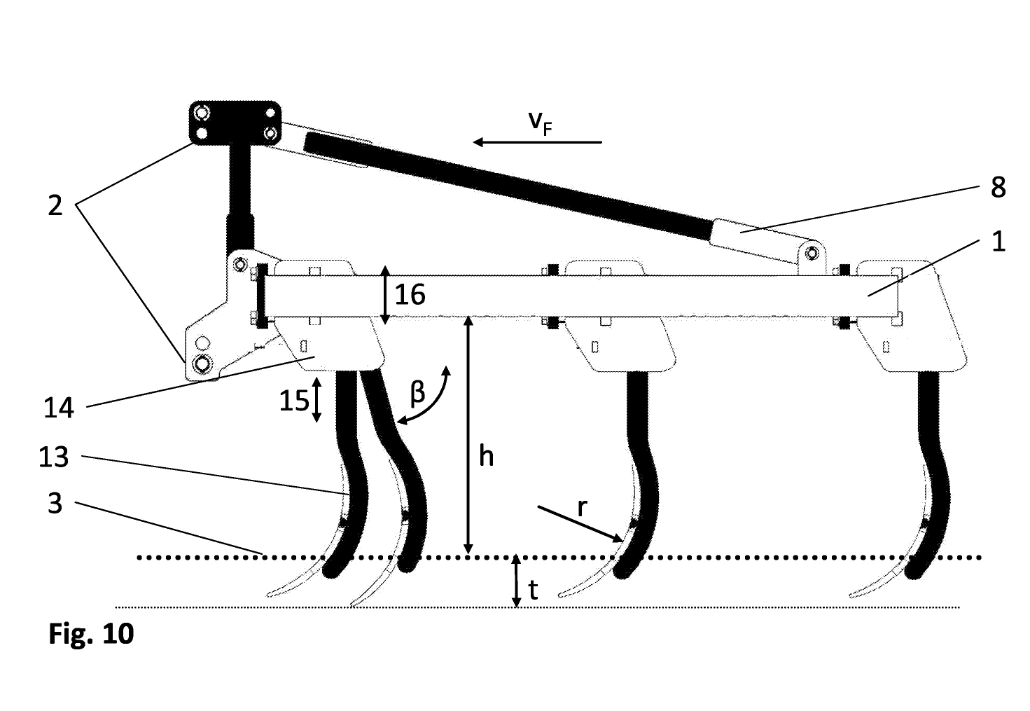

In accordance with the diagrams in FIG. 7 and FIG. 10, groups of tools that are arranged in a row are adjusted via actuators that are fastened to the machine frame 1 and that influence the corresponding equipment on the loosening tool.

Furthermore, the adjustment can be made in a centralized fashion for all of the tools or in a decentralized fashion for each tool individually; the central leg adjustment of entire tool rows and with a coupling to all of the tool rows takes place as it is already known from harrow technology (parallelogram guides).

The equipment for bringing about the adjustment can have an electrical, hydraulic, mechanical or pneumatic design. The adjustment takes place in a mechanical fashion in accordance with the diagram in FIG. 6.

A side view corresponding to FIG. 5 and FIG. 6 is shown in FIG. 7. FIG. 7 shows cultivator tools in back of one another in the direction of travel. The cultivator tools are arranged with the cultivator leg 5 fixed on the machine frame 1. A cultivator tine 6 is swivel-mounted in each case to the lower end of the cultivator leg 5 so that the tilt angle α can be changed. The adjustment is made via an adjustment rod 7 that acts on the cultivator tine 6. The adjustment rod 7 is driven by a control element 10 that is designed in the form of an actuator.

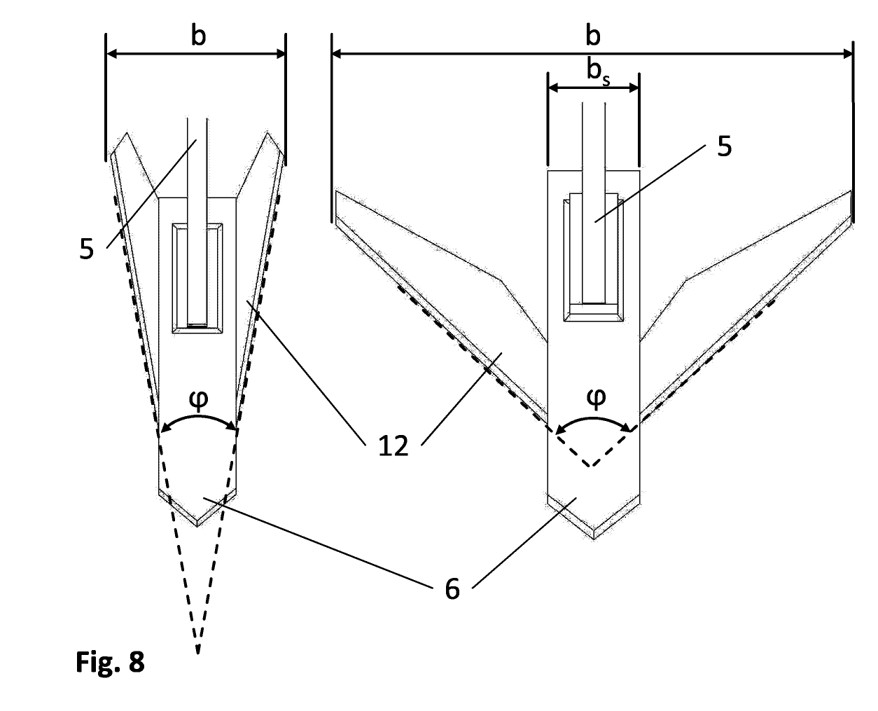

FIG. 8 shows a diagram of the tools with wings in a view from front and top. It illustrates the adjustment of the angle of spread via a swiveling of the wings around a nearly vertical axis close to the leg axis. The effective operating width/cutting width of the individual tool b is adjusted with that.

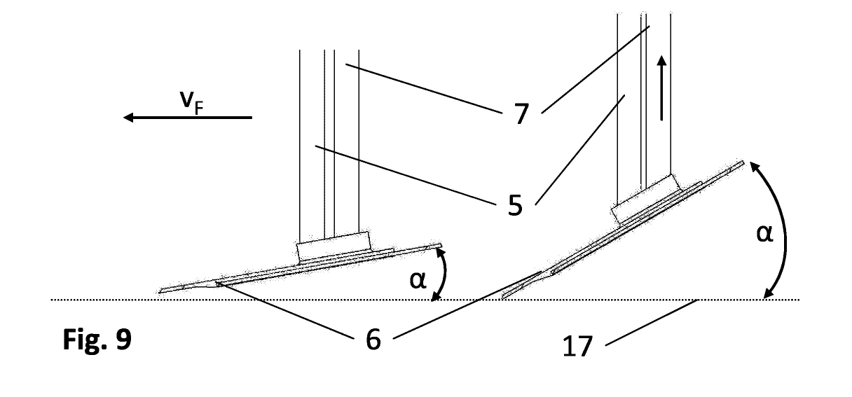

FIG. 9 shows a diagram of the tools in a side view. It illustrates the adjustment of the tilt angle via movement with the aid of a coupling rod. The tine is thereby swiveled around a horizontal cross-axis close to the attachment point of the tine. The tilt angle is adjusted in that way.

FIG. 10 shows a diagram of an arrangement of tools with one-piece, rigid cultivator legs and traditional tines. The tilt angle of the individual tool or tool group can be adjusted here via a swiveling of the tool leg around a horizontal cross-axis close to the attachment point of the leg on the frame of the tool crossbar. The operating depth of the individual tool or tool group is adjusted by moving the tool leg 15 or the tool crossbar 16.

### LIST OF REFERENCE NUMERALS

1—Central machine frame
2—Coupling frame for mounting on the rear lift of the tractor
3—Surface of the soil with organic top layers or vegetation
4—Support wheel, supporting body
5—Cultivator leg
6—Cultivator tine
7—Adjustment rod
8—Main frame strut
9—Height adjustment on the support wheel
10—Control element
11—Connection to the adjustment device
12—Wing
13—Cultivator blades
14—Coupling point
15—Tool leg
16—Tool crossbar
17—Processing floor (side view)
18—Approximate processing floor (front view)
20—Sensors
21—Tractor
22—Passive, pulled soil-cultivation device
23—Regulation unit
α—Tilt angle
β—Swivel angle
φ—Angle of spread
b—Tool width
bₛ—Tine width
v_{F}—Direction of travel
s—Line distance
t—Operating depth
h—Frame height (open passage)
r—Radius of curvature
D1 Input parameters (e.g. soil height beforehand)
D2 Disturbance variable (e.g. travel speed)
D3 Regulation unit
D4 Process variable (e.g. soil height afterwards)
D5 Regulation variable (e.g. cylinder stroke)
D6 Control element (e.g. actuator)
D7 Operating-result parameter (e.g. coverage of the ground)

1. A soil-cultivation, comprised of a tractor (21) and a driven soil-cultivation machine or comprised of a tractor (21) and a passive, pulled soil-cultivation device (22) for conservation-type soil cultivation, having an equipment carrier with cultivator tools for accommodating one or more cultivator tines (6), wherein
a regulation unit (23) is provided that accesses data that is recordable before and after travel over the work area in the work process and during the work process,
control elements (10) are provided, via which the cutting geometry of the cultivator tines (6) is adjusted,
the regulation unit (23) generates control variables from the recorded data for setting the cutting geometry during the work process, and
the cutting geometry of the cultivator tines (6) is is permanently adjusted during the work process as a result of the control variables that are generated.

2. The soil-cultivation unit according to claim 1, wherein
the operating depth of the cultivator tines (6), the tilt angle or swivel angle and the angle of spread are adjusted, individually or in combination, to set the cutting geometry of the cultivator tines (6), wherein the adjustment is registered in dependence upon parameters that are recorded in front of, in and in back of the soil-cultivation unit.

3. The soil-cultivation unit according to claim 2, wherein the operating depth of the cultivator tine (6) is adjusted via a vertical movement with respect to the surface of the soil.

4. The soil-cultivation unit according to claim 2, wherein the tilt angle or swivel angle of the cultivator tine (6) is adjusted via swiveling with respect to the surface of the soil.

5. The soil-cultivation unit according to claim 2, wherein the angle of spread of the cultivator tine (6) is adjusted with respect to the surface of the soil.

6. The soil-cultivation unit according to claim 2, wherein the operating depth, the tilt angle or swivel angle and/or the angle of spread is preset at the beginning of the soil cultivation.

7. The soil-cultivation unit according to claim 2, wherein the operating depth, the tilt angle or swivel angle and/or the angle of spread is adjusted in dependence upon the wear on the tine.

8. The soil-cultivation unit according to claim 2, wherein the operating depth, the tilt angle or swivel angle and/or the angle of spread is adjusted in a centralized fashion for the entire work implement or tool group, or in a decentralized fashion for each tool individually.

9. The soil-cultivation unit according to claim 2, wherein the operating depth, the tilt angle or swivel angle and/or the angle of spread is adjusted electrically, hydraulically, mechanically or pneumatically.

10. The soil-cultivation unit according to claim 4, wherein pivot points are provided for swiveling the tine in the area of the fastening point of the tine on the leg or in the area of the leg fixture.

11. The soil-cultivation unit according to claim 3, wherein an adjustment device is attached for vertical movement of individual tines/tine groups between the leg and the cultivator frame/the tine crossbar and the cultivator frame.

12. A method for cultivating the soil with a soil-cultivation unit, comprised of a tractor (21) and a driven soil-cultivation machine or comprised of a tractor (21) and a passive, pulled soil-cultivation device (22) for conservation-type soil cultivation, having an equipment carrier with cultivator tools for accommodating one or more cultivator tines (6), wherein
measurement data is recorded, sent to a regulation unit (23) and processed by it before and after travel over the work area in the work process and during the work process,
a permanent adjustment of the cutting geometry is made during the work process via control elements (10) for influencing the cutting geometry of the cultivator tines (6), for which
control signals are generated by the regulation unit (23) from measurement data recorded during the work process and transmitted to the control elements (10), wherein
the cutting geometry is set in such a way that the measurement data is within pre-determined tolerances during travel over the work area and consistent soil cultivation therefore takes place.
